(19) United States
(12) Patent Application Publication
(10) Pub. No.: US 2025/0382688 A1
(43) Pub. Date: Dec. 18, 2025

(54) ANISOTROPIC BULK MAGNET AND METHOD FOR MANUFACTURING THE SAME

(71) Applicant: KOREA INSTITUTE OF MATERIALS SCIENCE, Changwon-si (KR)

(72) Inventors: Jung Goo LEE, Changwon-si (KR); Hee Ryoung CHA, Changwon-si (KR); Tae Hoon KIM, Changwon-si (KR); Su Min KIM, Changwon-si (KR)

(21) Appl. No.: 19/199,741

(22) Filed: May 6, 2025

(30) Foreign Application Priority Data
Jun. 12, 2024 (KR) 10-2024-0076182

(51) Int. Cl. C22C 38/00; B22F 1/07; B22F 1/08; B22F 3/14; B22F 3/24; B22F 9/00; B22F 9/04; C22C 38/10; C22C 38/14; H01F 1/055

(52) U.S. Cl. CPC C22C 38/005; B22F 1/07; B22F 1/08; B22F 3/14; B22F 3/24; B22F 9/008; B22F 9/04; C22C 38/002; C22C 38/10; C22C 38/14; H01F 1/0557; B22F 2003/248; B22F 2301/355; B22F 2998/10; B22F 2999/00; C22C 2202/02

(57) ABSTRACT

The present disclosure relates to an anisotropic bulk magnet and a method for manufacturing the same. The anisotropic bulk magnet has a high fraction of a (Re,Ce)₂(Fe,Ti)₁₄B phase (magnetic phase), a low fraction of a (Re,Ce)Fe₂ phase (non-magnetic phase), a fine crystal grain size, an excellent degree of crystal grain alignment, and a high rare earth element content at an interface of the crystal grain, and therefore, may have excellent magnetic properties such as coercivity and maximum magnetic energy product.

### CROSS REFERENCE TO RELATED APPLICATION

The present application claims priority to and the benefit of Korean Patent Application No. 10-2024-0076182, filed on Jun. 12, 2024, the disclosure of which is incorporated herein by reference in its entirety.

### TECHNICAL FIELD

The present disclosure relates to an anisotropic bulk magnet and a method for manufacturing the same.

### BACKGROUND ART

As research and development on various devices and equipment have recently been actively conducted, demand for magnets used as a component has explosively increased. Particularly, demand for Nd—Fe—B magnets has gradually increased due to their excellent magnetic properties.

However, Nd is a rare earth metal and its reserves on earth are very small, and accordingly, the price is very high, causing an increase in the price of magnets. In addition, as the demand for Nd magnets increases, the supply of Nd is expected to be increasingly difficult in the future.

In order to solve this problem, there have been increased attempts to add other rare earth metals with higher production volumes and lower prices such as La and Ce instead of Nd. However, when adding other rare earth metals other than Nd, magnetic properties of a magnet are very inferior, making it difficult to replace existing Nd—Fe—B magnets.

Particularly, when manufacturing an anisotropic bulk magnet by adding Ce instead of Nd, a REFe₂ phase (RE is rare earth metal such as Nd or Ce included in alloy) is produced as a second phase. The produced REFe₂ phase has a Curie temperature of about 235 K and thus has paramagnetic properties at room temperature, reducing magnetic properties of the magnet. In addition, as the REFe₂ phase is produced, fractions of RE-rich phase and (Nd,Ce)₂Fe₁₄B main phase are reduced at the grain boundary, and since the CeFe₂ phase has a high melting point of 1198 K and is present in a solid state even during a hot deforming process, the CeFe₂ phase prevents crystal grains from being aligned along an easy magnetization axis in the corresponding process, reducing the degree of alignment of the crystal grains, and this causes a problem of declining magnetic properties of the finally formed anisotropic bulk magnet.

### DISCLOSURE

### Technical Problem

The present disclosure is directed to providing an anisotropic bulk magnet having excellent magnetic properties such as coercivity and maximum magnetic energy product, and a method for manufacturing the same.

However, objects to be achieved by the present disclosure are not limited to the object mentioned above, and other objects not mentioned will be clearly appreciated by those skilled in the art from the following description.

### Technical Solution

One embodiment 41 the present disclosure provides an anisotropic bulk magnet having a composition represented by a chemical formula of ReₐCe_{b}Ti_{c}Fe_{100-a-b-c-d-e}M_{d}Bₑ, wherein, in the chemical formula, Re is at least one selected from Nd, Sc, Y, La, Pr, Pm, Sm, Eu, Gd, Tb, Dy, Ho, Er, Tm, Yb and Lu, M is at least one selected from Ga, Co, Al, Cu, Nb, Si, Zr, Ta, V, Mo, Mn, Zn, Ni, Cr, Pb, Sn, In, Mg, Ag and Ge, a is greater than 0 and 20 or less, b is greater than 0 and 20 or less, c satisfies the following Equation 1, d is 0 or greater and 15 or less, and e is greater than 0 and 15 or less:

$$0.25 \times ( 10 \times X - 1 ) \leq c \leq 1.75 \times ( 10 \times X - 1 ) \qquad [ Equation 1 ]$$

in Equation 1, X is a total number of moles of the Ce element with respect to a total number of moles of the rare earth elements.

Another embodiment of the present disclosure provides a method for manufacturing the anisotropic bulk magnet, the method including: preparing magnetic powder; preparing an isotropic bulk magnet by pressure sintering the magnetic powder; and performing anisotropic bulking by hot deforming the isotropic bulk magnet.

### Advantageous Effects

An anisotropic bulk magnet according to one embodiment of the present disclosure has a high fraction of a (Re,Ce)₂(Fe,Ti)₁₄B phase (magnetic phase), a low fraction of a (Re,Ce)Fe₂ phase (non-magnetic phase), a fine crystal grain size, an excellent degree of crystal grain alignment, and a high rare earth element content at an interface of the crystal grain, and therefore, can have excellent magnetic properties such as coercivity and maximum magnetic energy product.

A method for manufacturing the anisotropic bulk magnet according to one embodiment of the present disclosure is capable of manufacturing an anisotropic bulk magnet having improved magnetic properties such as coercivity and maximum magnetic energy product.

Effects of the present disclosure are not limited to the above-described effects, and effects not mentioned will be clearly appreciated by those skilled in the art from the present specification.

### BRIEF DESCRIPTION OF DRAWINGS

FIG. 1 shows demagnetization curves of Example 1 and Comparative Example 1.

FIG. 2 shows demagnetization curves of Example 2 and Comparative Example 2.

FIG. 3 shows SEM images of Example 1 and Comparative Example 1.

FIG. 4 shows an average major axis length, an average minor axis length and an aspect ratio of crystal grains of Example 1 and Comparative Example 1.

FIG. 5 shows a result of XRD pattern of Example 1.

FIG. 6 shows a result of XRD pattern of Comparative Example 1.

FIG. 7 shows a result of evaluation on the degree of alignment of Example 1.

FIG. 8 shows a result of evaluation on the degree of alignment of Comparative Example 1.

FIG. 9 shows a SEM image and a line scan result of Example 1.

FIG. 10 shows a SEM image and a line scan result of Comparative Example 1.

FIG. 11 shows results of measuring remanence and coercivity of Example 1, Comparative Example 1, and Example 1-1 to Example 1-6.

FIG. 12 shows results of measuring remanence and coercivity of Example 2, Comparative Example 2, and Example 2-1 to Example 2-6.

FIG. 13 shows results of measuring remanence and coercivity of Example 1, Comparative Example 1, Example 1-1 to Example 1-6, Comparative Example 3, Example 3-1 to Example 3-4, Comparative Example 4, and Example 4-1 to Example 4-4.

### MODE FOR INVENTION

In the present specification, a description of a certain part “including” certain components means that it may further include other components, and does not exclude other components unless particularly stated on the contrary.

Throughout the specification of the present application, a unit “parts by weight” may mean a ratio of weight between each component.

Throughout the specification of the present application, “A and/or B” means “A and B, or A or B”.

Hereinafter, the present disclosure will be described in more detail.

One embodiment of the present disclosure provides an anisotropic bulk magnet having a composition represented by a chemical formula of ReₐCe_{b}Ti_{c}Fe_{100-a-b-c-d-e}M_{d}Bₑ, wherein, in the chemical formula, Re is at least one selected from Nd, Sc, Y, La, Pr, Pm, Sm, Eu, Gd, Tb, Dy, Ho, Er, Tm, Yb and Lu, M is at least one selected from Ga, Co, Al, Cu, Nb, Si, Zr, Ta, V, Mo, Mn, Zn, Ni, Cr, Pb, Sn, In, Mg, Ag and Ge, a is greater than 0 and 20 or less, b is greater than 0 and 20 or less, c satisfies the following Equation 1, d is 0 or greater and 15 or less, and e is greater than 0 and 15 or less:

$$0.25 \times ( 10 \times X - 1 ) \leq c \leq 1.75 \times ( 10 \times X - 1 ) \qquad [ Equation 1 ]$$

in Equation 1, X is the total number of moles of the Ce element with respect to the total number of moles of the rare earth elements.

According to one embodiment of the present disclosure, the anisotropic bulk magnet has, by including Ti, a high fraction of a (Re,Ce)₂(Fe,Ti)₁₄B phase (magnetic phase), a low fraction of a (Re,Ce)Fe₂ phase (non-magnetic phase), a fine crystal grain size, an excellent degree of crystal grain alignment, and a high rare earth element content at an interface of the crystal grain, and therefore, may have excellent magnetic properties such as coercivity and maximum magnetic energy product.

According to one embodiment of the present disclosure, the anisotropic bulk magnet may have a composition represented by a chemical formula of ReₐCe_{b}Ti_{c}Fe_{100-a-b-c-d-e}M_{d}Bₑ. In the chemical formula, Re may be at least one selected from Nd, Sc, Y, La, Pr, Pm, Sm, Eu, Gd, Tb, Dy, Ho, Er, Tm, Yb and Lu, M may be at least one selected from Ga, Co, Al, Cu, Nb, Si, Zr, Ta, V, Mo, Mn, Zn, Ni, Cr, Pb, Sn, In, Mg, Ag and Ge, a may be greater than 0 and 20 or less, b may be greater than 0 and 20 or less, c may satisfy the following Equation 1, d may be 0 or greater and 15 or less, and e may be greater than 0 and 15 or less, and the numerical value may mean atomic % (at %).

According to one embodiment of the present disclosure, a (content of Re) may be greater than 0 and 20 or less, greater than 0 and 15 or less, greater than 0 and 10 or less, 5 or greater and 20 or less, 5 or greater and 15 or less or 5 or greater and 10 or less, and b (content of Ce) may be greater than 0 and 20 or less, greater than 0 and 15 or less, greater than 0 and 10 or less, 5 or greater and 20 or less, 5 or greater and 15 or less or 5 or greater and 10 or less. In addition, d (content of M) may be 0 or greater and 15 or less, 0 or greater and 10 or less, greater than 0 and 15 or less, greater than 0 and 10 or less, 5 or greater and 15 or less or 5 or greater and 10 or less, and e (content of B) may be greater than 0 and 15 or less, greater than 0 and 10 or less, greater than 0 and 7.5 or less, 2.5 or greater and 15 or less, 2.5 or greater and 10 or less or 2.5 or greater and 7.5 or less. When the content of each of Nd, Re, M and/or B is in the above-described range, the anisotropic bulk magnet may have excellent magnetic properties.

According to one embodiment of the present disclosure, c (content of Ti) may satisfy the following Equation 1:

$$0.25 \times ( 10 \times X - 1 ) \leq c \leq 1.75 \times ( 10 \times X - 1 ) \qquad [ Equation 1 ]$$

in Equation 1, X is the total number of moles of the Ce element with respect to the total number of moles of the rare earth elements. In other words, X may be b/(a+b). Specifically, X may be 0.2 to 0.8, 0.2 to 0.6, 0.2 to 0.55, 0.2 to 0.5, 0.25 to 0.8, 0.25 to 0.6, 0.25 to 0.55, 0.25 to 0.5, 0.3 to 0.8, 0.3 to 0.6, 0.3 to 0.55 or 0.3 to 0.5, and c (content of Ti) may be 0.25 to 12.25, 0.25 to 8.75, 0.25 to 7.875, 0.25 to 7, 0.375 to 12.25, 0.375 to 8.75, 0.375 to 7.875, 0.375 to 7, 0.5 to 12.25, 0.5 to 8.75, 0.5 to 7.875, 0.5 to 7, 0.5 to 4, 0.5 to 3.5 or 0.5 to 2.25. When the content of Ti satisfies the above-described range, the anisotropic bulk magnet may have excellent magnetic properties such as coercivity and maximum magnetic energy product.

According to one embodiment of the present disclosure, the anisotropic bulk magnet may include the (Re,Ce)₂(Fe,Ti)₁₄B phase in an amount of 92 wt % or greater with respect to the total weight of the anisotropic bulk magnet. The anisotropic bulk magnet may have a high fraction of the (Re,Ce)₂(Fe,Ti)₁₄B phase, which is a magnetic phase, by including Ti. Specifically, the anisotropic bulk magnet may include the (Re,Ce)₂(Fe,Ti)₁₄B phase in an amount of 92 wt % or greater, 93 wt % or greater, 94 wt % or greater or 95 wt % or greater with respect to the total weight. When including the (Re,Ce)₂(Fe,Ti)₁₄B phase in the above-described range, the anisotropic bulk magnet may have excellent magnetic properties such as coercivity and maximum magnetic energy product.

According to one embodiment of the present disclosure, the anisotropic bulk magnet may include the (Re,Ce)Fe₂ phase in an amount of 5 wt % or less with respect to the total weight of the anisotropic bulk magnet. In the (Re,Ce)Fe₂ phase, Re may be the same as Re defined in the chemical formula, and in one embodiment of the present disclosure, the (Re,Ce)Fe₂ phase may be a CeFe₂ phase. In addition, the anisotropic bulk magnet may have a low fraction of the (Re,Ce)Fe₂ phase, which is a non-magnetic phase, by including Ti. Specifically, the anisotropic bulk magnet may include the (Re,Ce)Fe₂ phase in an amount of greater than 0 wt % and 5 wt % or less, greater than 0 wt % and 4 wt % or less, greater than 0 wt % and 3 wt % or less, greater than 0 wt % and 2 wt % or less or greater than 0 wt % and 1 wt % or less with respect to the total weight. When including the (Re,Ce)Fe₂ phase in the above-described range, the anisotropic bulk magnet may have excellent magnetic properties such as coercivity and maximum magnetic energy product.

According to one embodiment of the present disclosure, the anisotropic bulk magnet may have a standard deviation (σ) of 8° or less in the angle between crystal planes. The anisotropic bulk magnet may have an improved degree of alignment of the crystal phase by including Ti. Specifically, the anisotropic bulk magnet may have a standard deviation (σ) of 8° or less, 7.8° or less or 7.6° or less in the angle between crystal planes. When the standard deviation (σ) in the angle between crystal planes is in the above-described range, the anisotropic bulk magnet may have excellent magnetic properties such as remanence.

According to one embodiment of the present disclosure, the anisotropic bulk magnet may have coercivity of 11.5 kOe or greater and 20 kOe or less. Specifically, the coercivity may be 11.5 kOe or greater and 20 kOe or less, 11.5 kOe or greater and 18 kOe or less, 11.5 kOe or greater and 16 kOe or less, 15.5 kOe or greater and 20 kOe or less or 15.5 kOe or greater and 18 kOe or less.

According to one embodiment of the present disclosure, the anisotropic bulk magnet may have remanence of 10.5 kG or greater and 15 kG or less. Specifically, the remanence may be 10.5 kG or greater and 15 kG or less, 10.5 kG or greater and 13 kG or less, 12.2 kG or greater and 15 kG or less, 12.2 kG or greater and 13 kG or less or 12.2 kG or greater and 12.8 kG or less.

According to one embodiment of the present disclosure, the anisotropic bulk magnet may have an average minor axis length of the crystal grain of 10 nm to 100 nm. Specifically, an average minor axis length of the crystal grain may be 10 nm to 100 nm, 25 nm to 100 nm, 50 nm to 100 nm, 10 nm to 80 nm, 25 nm to 80 nm or 50 nm to 80 nm. When the average minor axis length of the crystal grain is in the above-described range, a fine crystal grain is obtained, so that the anisotropic bulk magnet may have excellent magnetic properties such as coercivity and maximum magnetic energy product.

According to one embodiment of the present disclosure, the anisotropic bulk magnet may have an average major axis length of the crystal grain of 125 nm to 275 nm, 125 nm to 250 nm, 125 nm to 225 nm, 150 nm to 275 nm, 150 nm to 250 nm, 150 nm to 225 nm, 175 nm to 275 nm, 175 nm to 250 nm or 175 nm to 225 nm. When the average major axis length of the crystal grain is in the above-described range, a fine crystal grain is obtained, so that the anisotropic bulk magnet may have excellent magnetic properties such as coercivity and maximum magnetic energy product.

According to one embodiment of the present disclosure, the crystal grain may have a plate shape, and in the plate-shaped crystal grain, the minor axis may be a length in a direction corresponding to the thickness, and the major axis may mean the largest width of one surface of the crystal grain perpendicular to the thickness direction.

According to one embodiment of the present disclosure, the anisotropic bulk magnet may have an aspect ratio (major axis/minor axis) of the crystal grain of 2.75 to 3.25, 2.75 to 3.2, 2.75 to 3.1, 2.8 to 3.25, 2.8 to 3.2, 2.8 to 3.1, 2.9 to 3.25, 2.9 to 3.2 or 2.9 to 3.1. When the aspect ratio of the crystal grain is in the above-described range, the crystal grain is well aligned in a direction of easy magnetization, improving the degree of alignment, and the anisotropic bulk magnet may have excellent magnetic properties such as remanence.

According to one embodiment of the present disclosure, the anisotropic bulk magnet may include the rare earth elements (Re and Ce) in an amount of 0.26 at % to 0.35 at %, 0.26 at % to 0.3 at %, 0.275 at % to 0.35 at % or 0.275 at % to 0.3 at % at an interface of the crystal grain. When the content of the rare earth elements at an interface of the crystal grain is in the above-mentioned range, the anisotropic bulk magnet may have excellent magnetic properties such as coercivity and maximum magnetic energy product.

One embodiment of the present disclosure provides a method for manufacturing the anisotropic bulk magnet, the method including: preparing magnetic powder; preparing an isotropic bulk magnet by pressure sintering the magnetic powder; and performing anisotropic bulking by hot deforming the isotropic bulk magnet.

The method for manufacturing the anisotropic bulk magnet according to one embodiment of the present disclosure increases a fraction of the (Re,Ce)₂(Fe,Ti)₁₄B phase (magnetic phase), reduces a fraction of the (Re,Ce)Fe₂ phase (non-magnetic phase), micronizes a size of the crystal grain, improves the degree of alignment of the crystal grain, and increases a content of the rare earth elements at an interface of the crystal grain, and therefore, an anisotropic bulk magnet having improved magnetic properties such as coercivity and maximum magnetic energy product may be manufactured.

Hereinafter, each step of the manufacturing method will be sequentially described in detail.

According to one embodiment of the present disclosure, the preparing of magnetic powder may include: preparing a ribbon by melt spinning an ingot including a metal; and preparing magnetic powder by pulverizing the ribbon.

According to one embodiment of the present disclosure, an ingot having a composition represented by a chemical formula of ReₐCe_{b}Ti_{c}Fe_{100-a-b-c-d-e}M_{d}Bₑ (ingot including metal) is prepared first. The preparing of an ingot may be preparing an ingot by mixing and melting a raw material having components corresponding to the composition in a content (atomic %) corresponding to the composition.

According to one embodiment of the present disclosure, the ingot including a metal is melt-spun to prepare a ribbon. In the melt spinning process, the ingot is melted and cooled on a metal wheel, generally a copper wheel, to be prepared into a ribbon shape.

According to one embodiment of the present disclosure, the ribbon may be pulverized to prepare magnetic powder. The pulverization is not particularly limited in the method, and may be performed using a method known in the corresponding technical field.

According to one embodiment of the present disclosure, the melt spinning may be performed at a rotation speed of 10 m/s or greater and 50 m/s or less. Specifically, the melt spinning may be performed at a rotation speed of 10 m/s or greater and 50 m/s or less, 10 m/s or greater and 40 m/s or less, 10 m/s or greater and less than 30 m/s, 15 m/s or greater and 25 m/s or less or 30 m/s or greater and 40 m/s or less. When the melt spinning is performed at the above-described rotation speed, the melted ingot is rapidly cooled, and the ribbon may be readily prepared. In addition, the cooling speed of the ribbon may be controlled by controlling the speed of the melt spinning, and a crystalline ribbon or an amorphous ribbon may be prepared.

According to one embodiment of the present disclosure, the magnetic powder may be crystalline or amorphous. As mentioned above, the magnetic powder is prepared by pulverizing a ribbon, and therefore, crystalline magnetic powder may be prepared when pulverizing a crystalline ribbon, and amorphous magnetic powder may be prepared when pulverizing an amorphous ribbon. By manufacturing the anisotropic bulk magnet from crystalline magnetic powder, coercivity, remanence and maximum magnetic energy product may be improved. In addition, by manufacturing the anisotropic bulk magnet from amorphous magnetic powder, coercivity and maximum magnetic energy product may be improved.

According to one embodiment of the present disclosure, an isotropic bulk magnet is prepared by pressure sintering the magnetic powder. The pressure sintering may be introducing the magnetic powder to a mold and applying pressure thereto, and a molded body prepared as above may be an isotropic bulk magnet, and crystal grains may be formed during the pressure sintering process.

According to one embodiment of the present disclosure, the pressure sintering is not particularly limited in the method as long as sintering is performed, but may be performed using any one method selected from the group consisting of, for example, hot pressure sintering, hot isostatic pressure sintering, discharge plasma sintering and microwave sintering. Specifically, the pressure sintering may be performed using, for example, a hot press device, and specifically, may use a device in which magnetic powder is inserted into a mold in a chamber, a temperature is raised to a specific temperature under vacuum or an inert gas atmosphere, and pressure is applied to the powder for sintering. The pressure sintering process is a step of densely binding the magnetic powder, and may be referred to as a step of bulking the magnet.

According to one embodiment of the present disclosure, the pressure sintering may be performed at a temperature of 500° C. to 900° C. and a pressure of 50 MPa to 1000 MPa. Specifically, the pressure sintering temperature may be 500° C. to 900° C., 500° C. to 800° C., 600° C. to 900° C. or 600° C. to 800° C., and the pressure sintering pressure may be 50 MPa to 1000 MPa, 50 MPa to 750 MPa, 50 MPa to 500 MPa, 50 MPa to 250 MPa or 50 MPa to 150 MPa. When the temperature and the pressure of the pressure sintering are in the above-described ranges, the outer surface of the magnetic powder is properly melted and sintered, and crystal grains with small (fine) sizes may be formed inside.

According to one embodiment of the present disclosure, the isotropic bulk magnet is hot deformed for anisotropic bulking. Through the hot deforming process, the crystal grains included in the isotropic bulk magnet may be aligned, and the anisotropic bulk magnet may be manufactured through such anisotropy.

According to one embodiment of the present disclosure, the hot deforming may be performed at a temperature of 500° C. to 900° C. Specifically, the temperature of the hot deforming may be 500° C. to 900° C., 500° C. to 800° C., 600° C. to 900° C. or 600° C. to 800° C. In addition, the hot deforming pressure may be 50 MPa to 1000 MPa, 50 MPa to 750 MPa, 50 MPa to 500 MPa, 50 MPa to 250 MPa, 50 MPa to 150 MPa or 100 MPa to 300 MPa. When the temperature and the pressure of the hot deforming are in the above-described ranges, the crystal grains of the isotropic bulk magnet may be well aligned in one direction, and accordingly, the anisotropic bulk magnet may have improved magnetic properties.

According to one embodiment of the present disclosure, the hot deforming may be performed so that a deformation rate represented by the following Equation 2 is 1 to 2:

$$ε = ln ( {h}_{0} / h ) \qquad [ Equation 2 ]$$

in Equation 2, ε means the deformation rate, h₀ is a height of the initial sample, and h is a height of the sample after deformation. When the deformation rate satisfies the above-described Equation 2, remanent flux density may increase due to the crystal grain anisotropy. Specifically, during the pressure sintering and hot deforming processes, the internal crystal grains may grow into a plate shape, and the plate shape may correspond to a shape stretched in a direction perpendicular to the direction facilitating magnetization. The melting point of the grain boundary phase of the crystal grain boundary is lower than the process temperature, and the grain boundary phase during the process is present in a liquid state. Herein, when the sample is pressed, the direction facilitating magnetization of each crystal grain is aligned horizontally to the pressing direction as the internal crystal grains rotate, and crystallographic anisotropy may be resulted.

According to one embodiment of the present disclosure, the hot deforming may be performed so that a deformation speed represented by the following Equation 3 is 0.001/s to 1.0/s:

$${ε}^{′} = ε / t \qquad [ Equation 3 ]$$

\acute{ε} is the deformation speed, ε is the deformation rate, and t is time. Specifically, the deformation speed may be 0.001/s to 1.0/s, 0.01/s to 1.0/s or 0.1/s to 1.0/s. When the deformation speed is in the above-described range, the crystallographic anisotropy may be readily achieved, and accordingly, the anisotropic bulk magnet may have improved magnetic properties.

According to one embodiment of the present disclosure, the method may further include, after the performing of anisotropic bulking by hot deforming the isotropic bulk magnet, post-heat treating the result.

According to one embodiment of the present disclosure, the post-heat treatment may be performed for 10 minutes to 600 minutes at a temperature of 500° C. to 1000° C. Specifically, the post-heat treatment temperature may be 500° C. to 1000° C., 500° C. to 800° C., 600° C. to 1000° C., 600° C. to 800° C. or 650° C. to 750° C., and the post-heat treatment time may be 10 minutes to 600 minutes, 10 minutes to 300 minutes, 10 minutes to 120 minutes, 30 minutes to 300 minutes, 30 minutes to 120 minutes or 30 minutes to 90 minutes. When the temperature and the time of the post-heat treatment are in the above-described ranges, the manufactured anisotropic bulk magnet may have improved magnetic properties.

Matters mentioned in the anisotropic bulk magnet and the method for manufacturing the anisotropic bulk magnet of the present disclosure are applied equally unless they are contradictory to each other.

Hereinafter, the present disclosure will be described in detail with reference to examples and experimental examples in order to specifically describe the present disclosure. However, examples and experimental examples according to the present disclosure may be modified to various different forms, and the scope of the present disclosure is not construed as being limited to the examples and the experimental examples described below. Examples and experimental examples of the present specification are provided in order to more fully describe the present disclosure to those having average knowledge in the art.

### Preparation Example 1. Preparation of Magnetic Powder

Metals including Fe, Nd, B, Ce, Co, Ga, Ti were prepared into an ingot having a composition of (Nd_{0.7}Ce_{0.3})_{13.6}Ti₂Fe_{bal}Ga_{0.6}Co_{6.6}B_{5.6} (at %) using an arc-melting method, and then the ingot was melt-spun at a wheel speed of 20 m/s to prepare a crystalline ribbon (nanocrystal ribbon). The prepared crystalline ribbon was pulverized into particles having an average diameter of 200 μm to prepare crystalline magnetic powder (nanocrystal magnetic powder). In the composition, “bal” means a remainder as a content that adds up to 100 with the content of all the other components.

### Preparation Example 2 to Preparation Example 4

Crystalline magnetic powder or amorphous magnetic powder of each of Preparation Example 2 to Preparation Example 4 was prepared in the same manner as in Preparation Example 1, except that a crystalline or amorphous ribbon was prepared by adjusting the composition of the ingot and the wheel speed during the melt spinning as shown in the following Table 1.

TABLE 1

| | | Crystallinity of |
|---|---|---|
| | Composition | Magnetic Powder |
| Preparation | (Nd_{0.7}Ce_{0.3})_{13.6}Ti₂Fe_{bal}Ga_{0.6}Co_{6.6}B_{5.6} | Crystalline |
| Example 1 | | |
| Preparation | (Nd_{0.7}Ce_{0.3})_{13.6}Ti₂Fe_{bal}Ga_{0.6}Co_{6.6}B_{5.6} | Amorphous |
| Example 2 | | |
| Preparation | (Nd_{0.7}Ce_{0.3})_{13.6}Fe_{bal}Ga_{0.6}Co_{6.6}B_{5.6} | Crystalline |
| Example 3 | | |
| Preparation | (Nd_{0.7}Ce_{0.3})_{13.6}Fe_{bal}Ga_{0.6}Co_{6.6}B_{5.6} | Amorphous |
| Example 4 | | |

### Example 1. Manufacture of Anisotropic Bulk Magnet

The crystalline magnetic powder prepared in Preparation Example 1 was introduced and put in a mold of a pressure sintering device, and press sintered at a pressure of up to 100 MPa for 20 minutes at 700° C. to be manufactured into an isotropic bulk magnet. The manufactured isotropic bulk magnet was hot deformed at 700° C. and a deformation speed of 0.1 s⁻¹ to achieve a deformation rate of 1.5 for anisotropic bulking, and then the result was post-heat treated for 1 hour at 700° C. to manufacture an anisotropic bulk magnet.

### Example 2, Comparative Example 1 and Comparative Example 2

Anisotropic bulk magnets of Example 2, Comparative Example 1 and Comparative Example 2 were manufactured in the same manner as in Example 1, except that the magnetic powder was adjusted as in the following Table 2.

TABLE 2

| Anisotropic | | Crystallinity of |
|---|---|---|
| Bulk Magnet | Magnetic Powder | Magnetic Powder |
| Example 1 | Preparation Example 1 | Crystalline |
| Example 2 | Preparation Example 2 | Amorphous |
| Comparative Example 1 | Preparation Example 3 | Crystalline |
| Comparative Example 2 | Preparation Example 4 | Amorphous |

### Experimental Example 1. Evaluation on Magnetic Properties

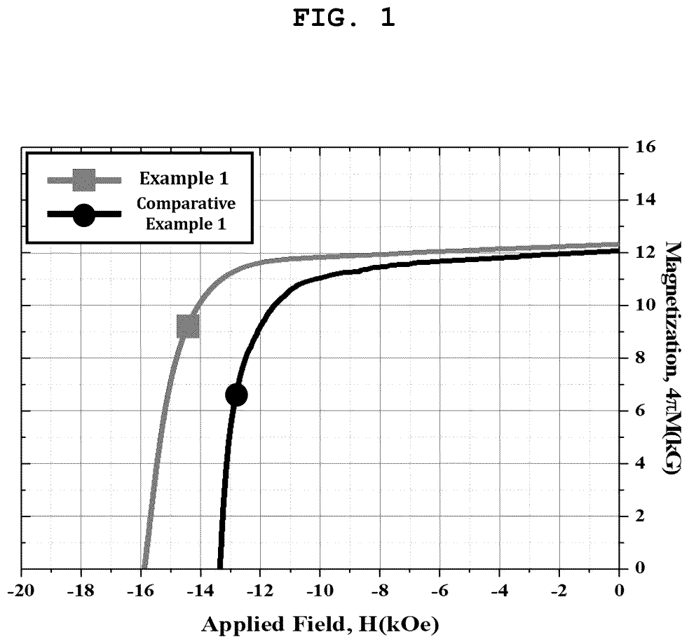

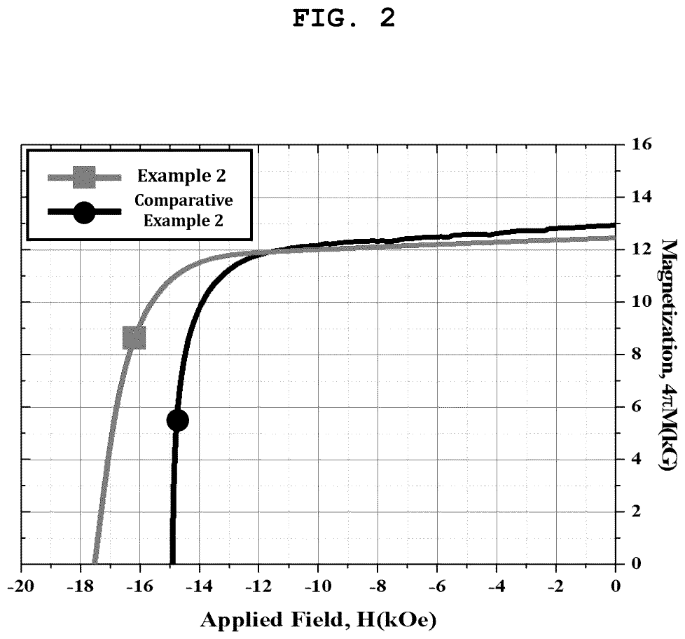

Each of the anisotropic bulk magnets manufactured in Example 1, Example 2, Comparative Example 1 and Comparative Example 2 was processed into a specimen having a size of 3 mm×3 mm×1 mm, and then magnetized using a pulse magnetic field of 7 T. The magnetized specimen was swept by applying a magnetic field ranging from −1.8 T to 1.8 T using a vibrating sample magnetometer (VSM, LakeShore) to measure coercivity and remanence, which are magnetic properties, and the results are shown as demagnetization curves of FIGS. 1 and 2.

As shown in FIGS. 1 and 2, it was identified that the anisotropic bulk magnets of Example 1 and Example 2 including Ti had superior coercivity compared to the anisotropic bulk magnets of Comparative Example 1 and Comparative Example 2 that do not include Ti.

In addition, the graph areas of Example 1 and Example 2 are wider than the graph areas of Comparative Example 1 and Comparative Example 2 in FIGS. 1 and 2, and therefore, it may be seen that Example 1 and Example 2 have an excellent maximum magnetic energy product (BHₘₐₓ) as well.

### Experimental Example 2. Measurement of SEM Image

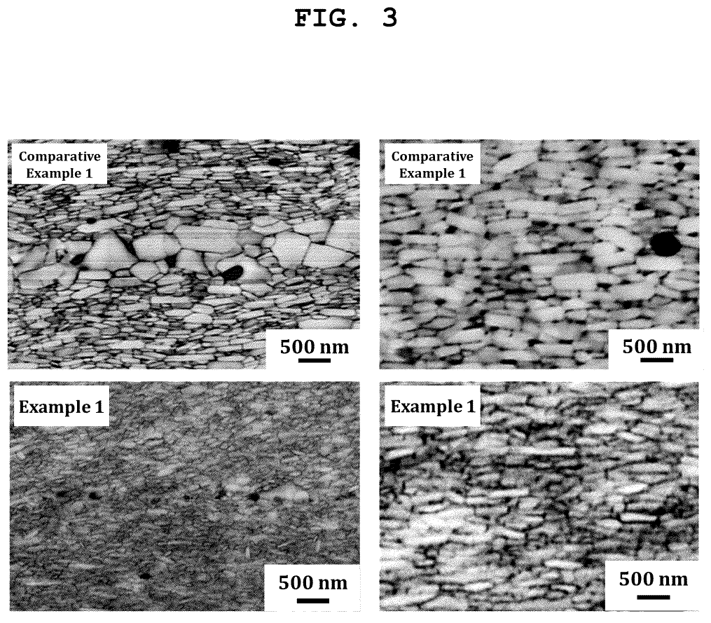

The cross-section of the anisotropic bulk magnet manufactured in each of Example 1 and Comparative Example 1 was photographed using a scanning electron microscope (SEM, JEOL Ltd., 7001F), and the results are shown in FIG. 3.

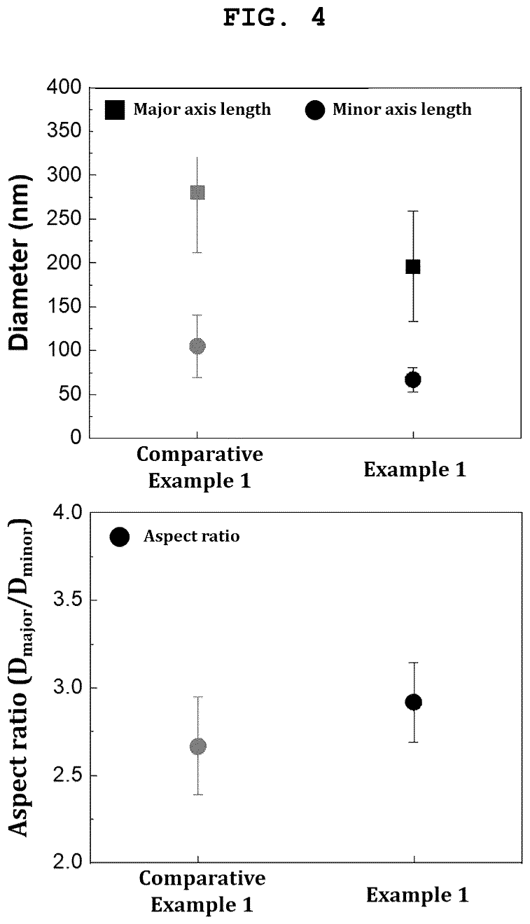

In addition, using the SEM images of FIG. 3, an average minor axis length, an average major axis length and an aspect ratio of the crystal grains of each of Example 1 and Comparative Example 1 were measured, and the results are shown FIG. 4.

As shown in FIGS. 3 and 4, it was identified that the anisotropic bulk magnet of Example 1 including Ti had a smaller crystal grain size and an increased aspect ratio compared to the anisotropic bulk magnet of Comparative Example 1 that does not include Ti.

Accordingly, it may be seen that the anisotropic bulk magnet of Example 1 suppresses crystal grain growth (crystal grain is micronized) by including Ti, and has improved coercivity and maximum magnetic energy product.

### Experimental Example 3. Measurement of XRD

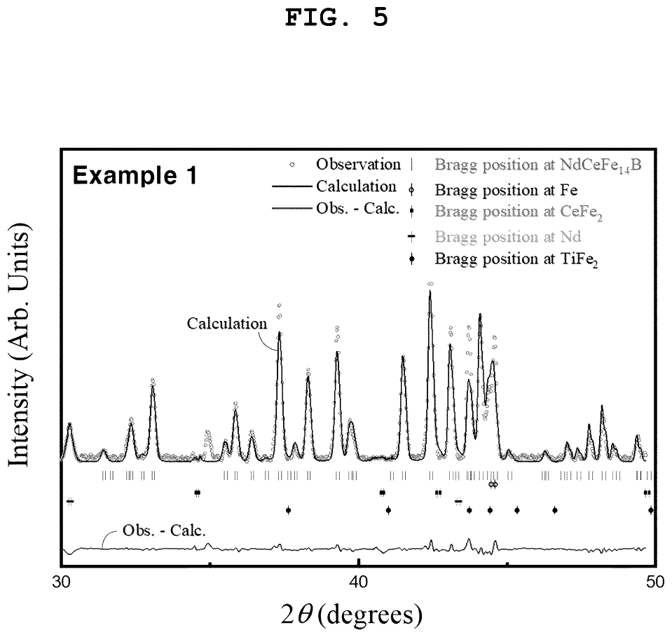

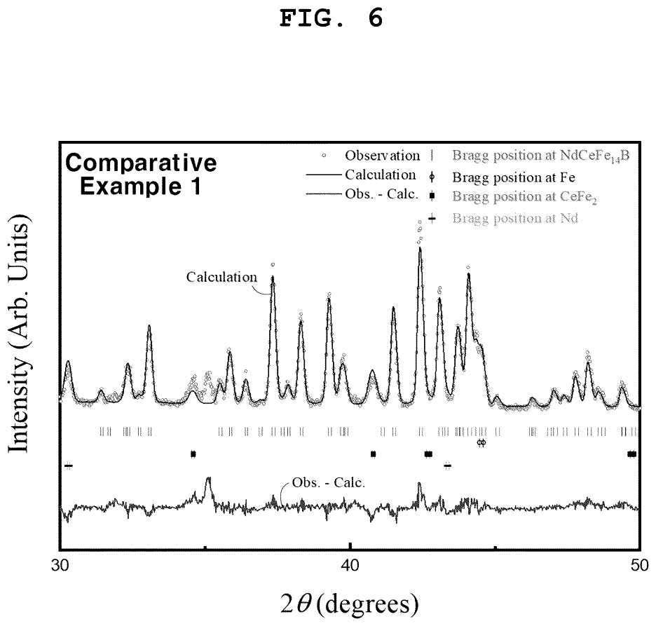

For each of the anisotropic bulk magnets manufactured in Example 1 and Comparative Example 1, an x-ray diffraction (XRD) pattern was analyzed using an X-ray diffractometer (XRD, RIGAKU, D/MAX-2500), and the results are shown in FIGS. 5 and 6.

In addition, using the XRD patterns of FIGS. 5 and 6, the weight fraction (wt %) of the crystal phase with respect to the total weight of each of the anisotropic bulk magnets of Example 1 and Comparative Example 1 was measured, and the results are shown in Table 3.

TABLE 3

| | Weight | Comparative | Weight |
|---|---|---|---|
| Example 1 | Fraction (wt %) | Example 1 | Fraction (wt %) |
| (Nd,Ce)₂(Fe,Ti)₁₄B | 95.17 | (Nd,Ce)₂Fe₁₄B | 90.38 |
| Fe | 0.04 | Fe | 0.44 |
| CeFe₂ | 0.65 | CeFe₂ | 6.98 |
| Nd | 2.49 | Nd | 2.20 |
| TiFe₂ | 1.65 | | |

As shown in FIGS. 5 and 6 and Table 3, it was identified that the anisotropic bulk magnet of Example 1 including Ti had an increased fraction of the (Nd,Ce)₂(Fe,Ti)₁₄B phase (magnetic phase) including rare earth elements (Nd, Ce) and a decreased fraction of the CeFe₂ phase (non-magnetic phase) compared to the anisotropic bulk magnet of Comparative Example 1 that does not include Ti.

Accordingly, it may be seen that the anisotropic bulk magnet of Example 1 has an increased fraction of the main phase (magnetic phase) and a decreased fraction of the secondary phase (non-magnetic phase) fraction by including Ti, thereby having improved coercivity and maximum magnetic energy product.

### Experimental Example 4. Evaluation on Degree of Alignment

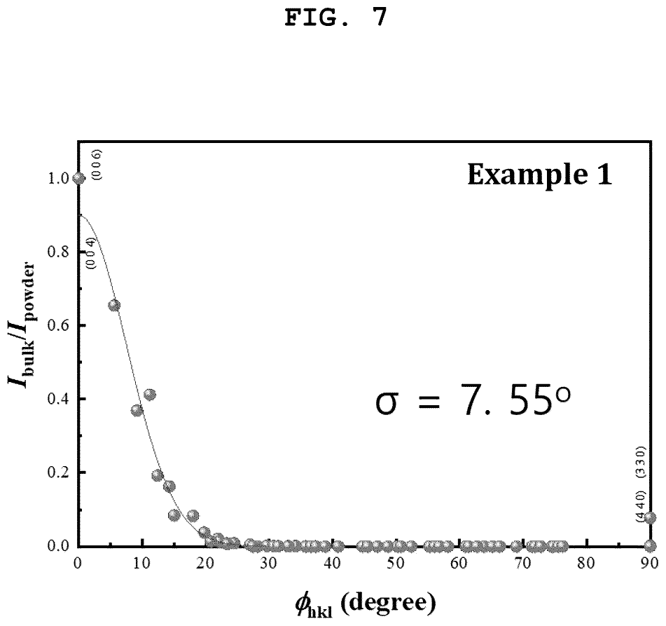

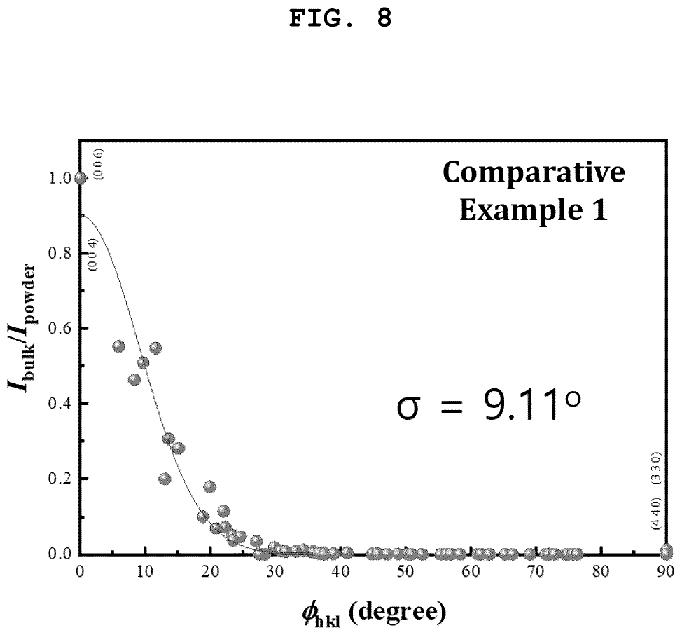

For each of the anisotropic bulk magnets manufactured in Example 1 and Comparative Example 1, a standard deviation of Gaussian distribution for the angle between the (hkl) surface and the (001) surface and the relative XRD peak intensity (ratio of XRD peak intensity of manufactured magnet with respect to XRD peak intensity of isotropic powder) was calculated based on the XRD pattern analysis results to evaluate the degree of alignment, and the results are shown in FIGS. 7 and 8.

As shown in FIGS. 7 and 8, it was identified that the anisotropic bulk magnet of Example 1 including Ti had a smaller standard deviation (σ) in the angle between crystal planes compared to the anisotropic bulk magnet of Comparative Example 1 that does not include Ti. Herein, having a small standard deviation means that the c-axis of each crystal grain in the magnet is well aligned in one direction.

Accordingly, it may be seen that the anisotropic bulk magnet of Example 1 has an improved degree of alignment of the crystal phase and improved remanence by including Ti.

### Experimental Example 5. Evaluation on Element Content in Crystal Grain and at Interface

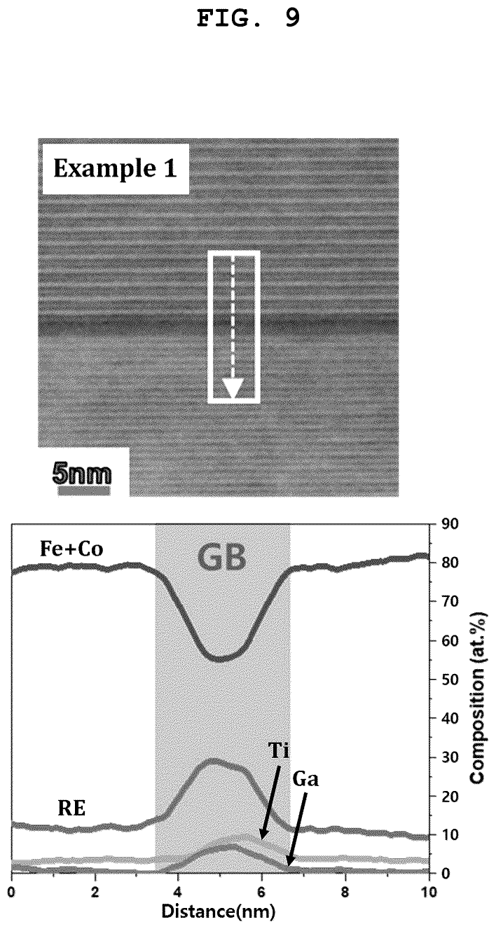

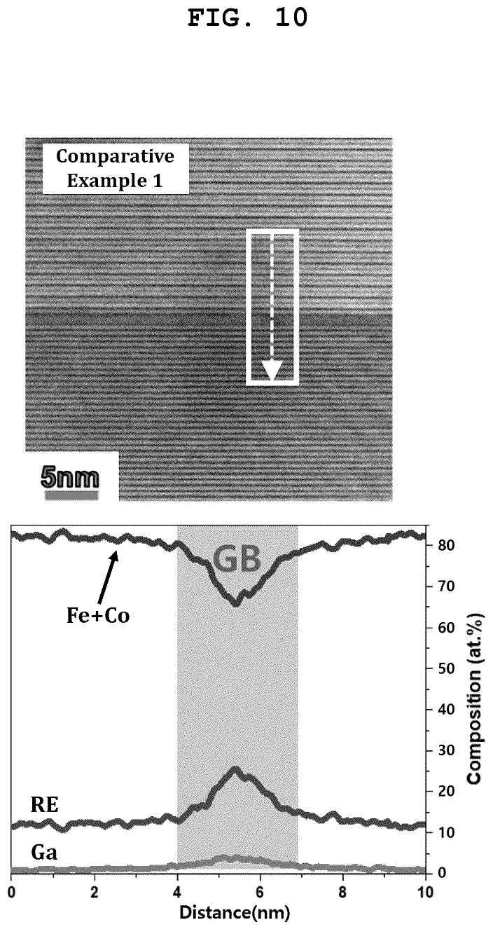

For each of the anisotropic bulk magnets manufactured in Example 1 and Comparative Example 1, a SEM image was measured in the same manner as in Experimental Example 2, and the results are shown in FIGS. 9 and 10.

In addition, the content of each element was measured by conducting line scanning in the direction of straight line (arrow on TEM image) between the crystal grains in FIGS. 9 and 10, and the results are shown in FIGS. 9 and 10 and Table 4.

TABLE 4

| | | Element | | | Element |
|---|---|---|---|---|---|
| | Element | Content at | | Element | Content at |
| | Content of | Crystal | | Content of | Crystal |
| | Crystal | Grain | | Crystal | Grain |
| | Grain | Interface | Comparative | Grain | Interface |
| Example 1 | (at %) | (at %) | Example 1 | (at %) | (at %) |
| RE (Nd | 11.79 | 28.62 | RE (Nd | 11.79 | 25.54 |
| and Ce) | | | and Ce) | | |
| Fe and Co | 78.81 | 55.10 | Fe and Co | 82.32 | 65.68 |
| Ga | — | 6.55 | Ga | 1.06 | 3.87 |
| Ti | 3.52 | 8.29 | | | |

As shown in FIGS. 9 and 10 and Table 4, it was identified that the anisotropic bulk magnet of Example 1 including Ti had an increased rare earth element (Nd and Ce) content at the crystal grain interface compared to the anisotropic bulk magnet of Comparative Example 1 that does not include Ti.

Accordingly, it may be seen that the anisotropic bulk magnet of Example 1 has an increased rare earth element content at the crystal grain interface by including Ti, thereby having improved coercivity and maximum magnetic energy product.

### Example 1-1 to Example 1-6, and Example 2-1 to Example 2-6

Anisotropic bulk magnets of Example 1-1 to Example 1-6, and Example 2-1 to Example 2-6 were manufactured in the same manner as in Preparation Example 1 and Example 1, except that the composition and the crystallinity of the magnetic powder were adjusted as in the following Table 5.

TABLE 5

| Anisotropic | | Crystallinity of |
|---|---|---|
| Bulk Magnet | Composition | Magnetic Powder |
| Example 1 | (Nd_{0.7}Ce_{0.3})_{13.6}Ti₂Fe_{bal}Ga_{0.6}Co_{6.6}B_{5.6} | Crystalline |
| Comparative | (Nd_{0.7}Ce_{0.3})_{13.6}Fe_{bal}Ga_{0.6}Co_{6.6}B_{5.6} | Crystalline |
| Example 1 | | |
| Example 1-1 | (Nd_{0.7}Ce_{0.3})_{13.6}Ti_{0.5}Fe_{bal}Ga_{0.6}Co_{6.6}B_{5.6} | Crystalline |
| Example 1-2 | (Nd_{0.7}Ce_{0.3})_{13.6}Ti₁Fe_{bal}Ga_{0.6}Co_{6.6}B_{5.6} | Crystalline |
| Example 1-3 | (Nd_{0.7}Ce_{0.3})_{13.6}Ti_{1.5}Fe_{bal}Ga_{0.6}Co_{6.6}B_{5.6} | Crystalline |
| Example 1-4 | (Nd_{0.7}Ce_{0.3})_{13.6}Ti_{2.5}Fe_{bal}Ga_{0.6}Co_{6.6}B_{5.6} | Crystalline |
| Example 1-5 | (Nd_{0.7}Ce_{0.3})_{13.6}Ti₃Fe_{bal}Ga_{0.6}Co_{6.6}B_{5.6} | Crystalline |
| Example 1-6 | (Nd_{0.7}Ce_{0.3})_{13.6}Ti₄Fe_{bal}Ga_{0.6}Co_{6.6}B_{5.6} | Crystalline |
| Example 2 | (Nd_{0.7}Ce_{0.3})_{13.6}Ti₂Fe_{bal}Ga_{0.6}Co_{6.6}B_{5.6} | Amorphous |
| Comparative | (Nd_{0.7}Ce_{0.3})_{13.6}Fe_{bal}Ga_{0.6}Co_{6.6}B_{5.6} | Amorphous |
| Example 2 | | |
| Example 2-1 | (Nd_{0.7}Ce_{0.3})_{13.6}Ti_{0.5}Fe_{bal}Ga_{0.6}Co_{6.6}B_{5.6} | Amorphous |
| Example 2-2 | (Nd_{0.7}Ce_{0.3})_{13.6}Ti₁Fe_{bal}Ga_{0.6}Co_{6.6}B_{5.6} | Amorphous |
| Example 2-3 | (Nd_{0.7}Ce_{0.3})_{13.6}Ti_{1.5}Fe_{bal}Ga_{0.6}Co_{6.6}B_{5.6} | Amorphous |
| Example 2-4 | (Nd_{0.7}Ce_{0.3})_{13.6}Ti_{2.5}Fe_{bal}Ga_{0.6}Co_{6.6}B_{5.6} | Amorphous |
| Example 2-5 | (Nd_{0.7}Ce_{0.3})_{13.6}Ti₃Fe_{bal}Ga_{0.6}Co_{6.6}B_{5.6} | Amorphous |
| Example 2-6 | (Nd_{0.7}Ce_{0.3})_{13.6}Ti₄Fe_{bal}Ga_{0.6}Co_{6.6}B_{5.6} | Amorphous |

### Experimental Example 6. Evaluation on Magnetic Properties of Anisotropic Bulk Magnet Depending on Ti Content

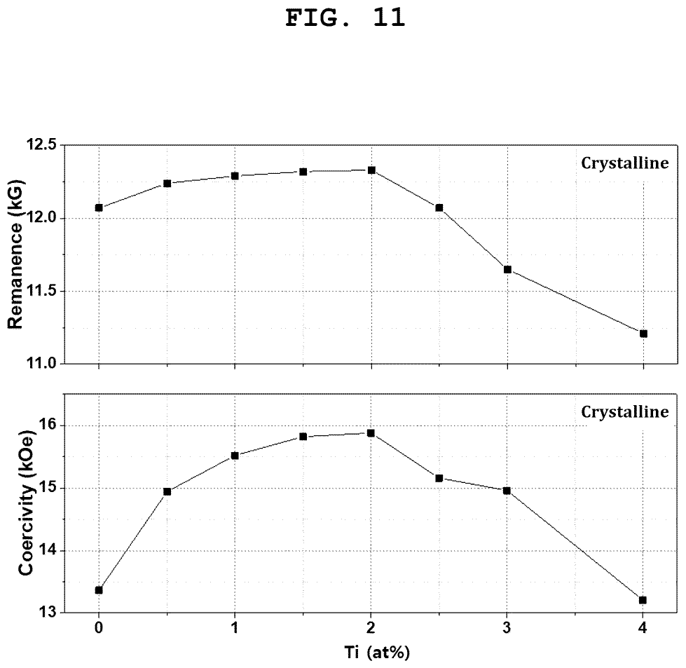

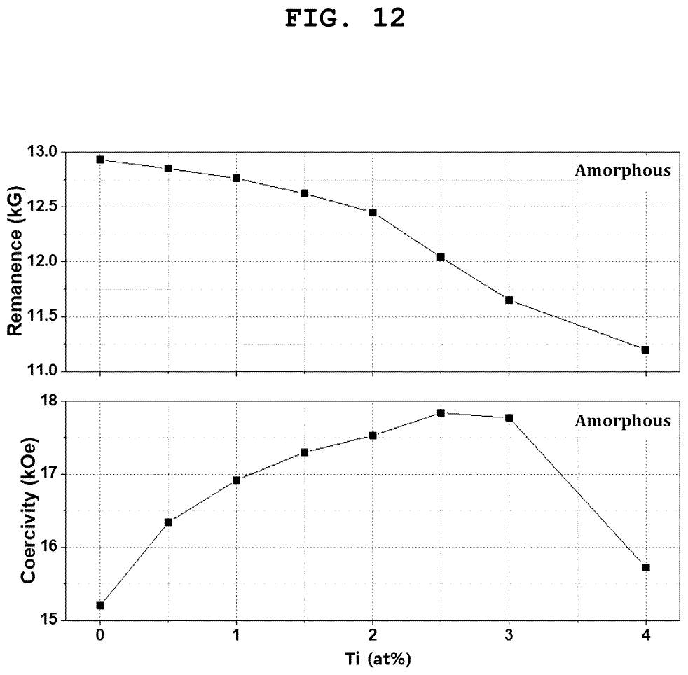

For each of the anisotropic bulk magnets manufactured in Example 1, Comparative Example 1, Example 1-1 to Example 1-6, Example 2, Comparative Example 2, and Example 2-1 to Example 2-6, magnetic properties were evaluated in the same manner as in Experimental Example 1, and the results are shown in FIGS. 11 and 12.

As shown in FIG. 11, it was identified that the anisotropic bulk magnet manufactured with crystalline magnetic powder had superior coercivity when including Ti in the content of greater than 0 at % and less than 4 at % compared to the anisotropic bulk magnet that does not include Ti.

As shown in FIG. 12, it was identified that the anisotropic bulk magnet manufactured with amorphous magnetic powder had superior coercivity when including Ti in the content of greater than 0 at % and 4 at % or less compared to the anisotropic bulk magnet that does not include Ti.

### Example 3-1 to Example 3-4, Example 4-1 to Example 4-4, Comparative Example 3 and Comparative Example 4

Anisotropic bulk magnets of Example 3-1 to Example 3-4, Example 4-1 to Example 4-4, Comparative Example 3 and Comparative Example 4 were manufactured in the same manner as in Preparation Example 1 and Example 1, except that the composition and the crystallinity of the magnetic powder were adjusted as in the following Table 6.

TABLE 6

| Anisotropic | | Crystallinity of |
|---|---|---|
| Bulk Magnet | Composition | Magnetic Powder |
| Comparative | (Nd_{0.6}Ce_{0.4})_{13.6}Fe_{bal}Ga_{0.6}Co_{6.6}B_{5.6} | Crystalline |
| Example 3 | | |
| Example 3-1 | (Nd_{0.6}Ce_{0.4})_{13.6}Ti₁Fe_{bal}Ga_{0.6}Co_{6.6}B_{5.6} | Crystalline |
| Example 3-2 | (Nd_{0.6}Ce_{0.4})_{13.6}Ti₂Fe_{bal}Ga_{0.6}Co_{6.6}B_{5.6} | Crystalline |
| Example 3-3 | (Nd_{0.6}Ce_{0.4})_{13.6}Ti₃Fe_{bal}Ga_{0.6}Co_{6.6}B_{5.6} | Crystalline |
| Example 3-4 | (Nd_{0.6}Ce_{0.4})_{13.6}Ti₄Fe_{bal}Ga_{0.6}Co_{6.6}B_{5.6} | Crystalline |
| Comparative | (Nd_{0.5}Ce_{0.5})_{13.6}Fe_{bal}Ga_{0.6}Co_{6.6}B_{5.6} | Crystalline |
| Example 4 | | |
| Example 4-1 | (Nd_{0.5}Ce_{0.5})_{13.6}Ti₁Fe_{bal}Ga_{0.6}Co_{6.6}B_{5.6} | Crystalline |
| Example 4-2 | (Nd_{0.5}Ce_{0.5})_{13.6}Ti₂Fe_{bal}Ga_{0.6}Co_{6.6}B_{5.6} | Crystalline |
| Example 4-3 | (Nd_{0.5}Ce_{0.5})_{13.6}Ti₃Fe_{bal}Ga_{0.6}Co_{6.6}B_{5.6} | Crystalline |

### Experimental Example 7. Evaluation on Magnetic Properties of Anisotropic Bulk Magnet Depending on Ce and Ti Content

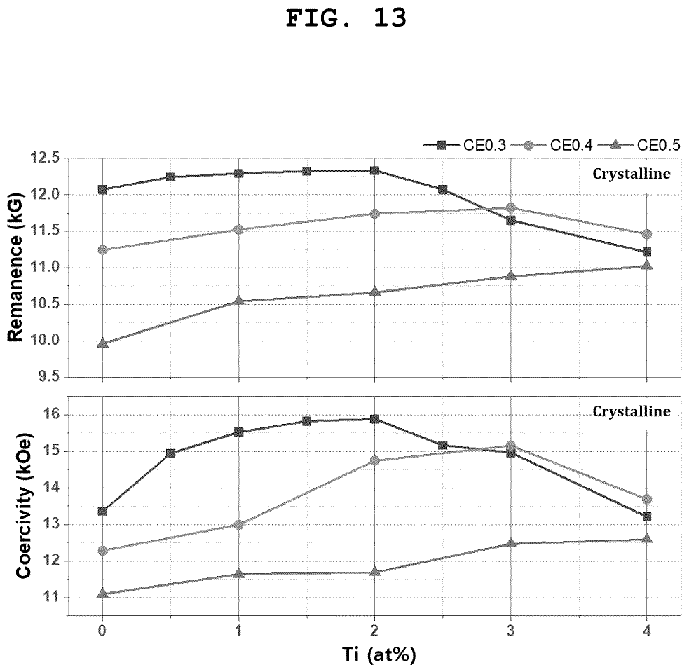

For each of the anisotropic bulk magnets manufactured in Example 1, Comparative Example 1, Example 1-1 to Example 1-6, Comparative Example 3, Example 3-1 to Example 3-4, Comparative Example 4, and Example 4-1 to Example 4-4, magnetic properties were evaluated in the same manner as in Experimental Example 1, and the results are shown in FIG. 13.

As shown in FIG. 13, it was identified that, when the number of moles of Ce with respect to the total number of moles of the rare earth elements (Nd and Ce) (mole fraction of Ce element with respect to total rare earth elements) is 0.3, the anisotropic bulk magnet including Ti in the content of greater than 0 at % and less than 4 at had superior coercivity compared to the anisotropic bulk magnet that does not include Ti.

It was identified that, when the number of moles of Ce with respect to the total number of moles of the rare earth elements (Nd and Ce) (mole fraction of Ce element with respect to total rare earth elements) is 0.4, the anisotropic bulk magnet including Ti had superior coercivity compared to the anisotropic bulk magnet that does not include Ti.

It was identified that, when the number of moles of Ce with respect to the total number of moles of the rare earth elements (Nd and Ce) (mole fraction of Ce element with respect to total rare earth elements) is 0.5, the anisotropic bulk magnet including Ti had superior coercivity compared to the anisotropic bulk magnet that does not include Ti.

In addition, it may be seen that the anisotropic bulk magnet including Ti has excellent coercivity when the Ti content satisfies the following Equation 1.

$$0.25 \times ( 10 \times X - 1 ) \leq Ti content \leq 1.75 \times ( 10 \times X - 1 ) \qquad [ Equation 1 ]$$

In Equation 1, X is the number of moles of Ce with respect to the total number of moles of the rare earth elements (mole fraction of Ce element with respect to total rare earth elements).

Hereinbefore, the present disclosure has been described with limited examples, however, the present disclosure is not limited thereto, and it is obvious that various changes and modifications may be made by those skilled in the art within technical ideas of the present disclosure and the range of equivalents of the claims to be described.

1. An anisotropic bulk magnet having a composition represented by a chemical formula of ReₐCe_{b}Ti_{c}Fe_{100-a-b-c-d-e}M_{d}Bₑ,
wherein, in the chemical formula, Re is at least one selected from Nd, Sc, Y, La, Pr, Pm, Sm, Eu, Gd, Tb, Dy, Ho, Er, Tm, Yb and Lu, M is at least one selected from Ga, Co, Al, Cu, Nb, Si, Zr, Ta, V, Mo, Mn, Zn, Ni, Cr, Pb, Sn, In, Mg, Ag and Ge, a is greater than 0 and 20 or less, b is greater than 0 and 20 or less, c satisfies the following Equation 1, d is 0 or greater and 15 or less, and e is greater than 0 and 15 or less:
$$0.25 \times ( 10 \times X - 1 ) \leq c \leq 1.75 \times ( 10 \times X - 1 ) \qquad [ Equation 1 ]$$
in Equation 1, X is a total number of moles of the Ce element with respect to a total number of moles of the rare earth elements.

2. The anisotropic bulk magnet of claim 1, which includes a (Re,Ce)₂(Fe,Ti)₁₄B phase in an amount of 92 wt % or greater with respect to a total weight of the anisotropic bulk magnet.

3. The anisotropic bulk magnet of claim 1, which includes a (Re,Ce)Fe₂ phase in an amount of 5 wt % or less with respect to a total weight of the anisotropic bulk magnet.

4. The anisotropic bulk magnet of claim 1, which has a standard deviation (σ) in an angle between crystal planes of 8° or less.

5. The anisotropic bulk magnet of claim 1, which has coercivity of 11.5 kOe or greater and 20 kOe or less.

6. The anisotropic bulk magnet of claim 1, which has remanence of 10.5 kG or greater and 15 kG or less.

7. The anisotropic bulk magnet of claim 1, which has an average minor axis length of a crystal grain of 10 nm to 100 nm.

8. A method for manufacturing the anisotropic bulk magnet of claim 1, the method comprising:
preparing magnetic powder;
preparing an isotropic bulk magnet by pressure sintering the magnetic powder; and
performing anisotropic bulking by hot deforming the isotropic bulk magnet.

9. The method of claim 8, wherein the preparing of magnetic powder includes:
preparing a ribbon by melt spinning an ingot including a metal; and
preparing magnetic powder by pulverizing the ribbon.

10. The method of claim 8, wherein the magnetic powder is crystalline or amorphous.

11. The method of claim 8, wherein the press sintering is performed at a temperature of 500° C. to 900° C. and a pressure of 50 MPa to 1000 MPa.

12. The method of claim 8, wherein the hot deforming is performed at a temperature of 500° C. to 900° C.

13. The method of claim 8, wherein the hot deforming is performed so that a deformation rate represented by the following Equation 2 is 1 to 2:
$$ε = ln ( {h}_{0} / h ) \qquad [ Equation 2 ]$$
in Equation 2, ε means the deformation rate, h₀ is a height of an initial sample, and h is a height of the sample after deformation.

14. The method of claim 8, wherein the hot deforming is performed so that a deformation speed represented by the following Equation 3 is 0.001/s to 1.0/s:
$${ε}^{′} = ε / t \qquad [ Equation 3 ]$$
\acute{ε} is the deformation speed, ε is a deformation rate, and t is time.

15. The method of claim 8, further comprising, after the performing of anisotropic bulking by hot deforming the isotropic bulk magnet, post-heat treating the result.

16. The method of claim 15, wherein the post-heat treatment is performed for 10 minutes to 600 minutes at a temperature of 500° C. to 1000° C.
